(19) United States
(12) Patent Application Publication
(10) Pub. No.: US 2025/0054107 A1
(43) Pub. Date: Feb. 13, 2025

(54) CARGO INSPECTION SYSTEM AND A METHOD FOR DISCRIMINATING MATERIAL IN AN X-RAY IMAGING CARGO INSPECTION

(71) Applicant: Billion Prima Sdn Bhd, Johor (MY)

(72) Inventors: Ameer Safuan Bin MUHAMAD KAHIRI, Kulai (MY); Chin Yip SIEW, Kulai (MY); Chu Leong GOH, Kulai (MY); Yuh Jiunn LEE, Kulai (MY)

(21) Appl. No.: 18/784,574

(22) Filed: Jul. 25, 2024

(30) Foreign Application Priority Data
Aug. 7, 2023 (MY) PI2023004760

(51) Int. Cl. G06T 5/50; G01N 23/04; G01N 23/083; G01N 23/10; G06T 1/20; G06T 3/40; G06T 5/20; G06T 5/70; G06V 10/762; G06V 10/764

(52) U.S. Cl. CPC G06T 5/50; G01N 23/04; G01N 23/083; G01N 23/10; G06T 1/20; G06T 3/40; G06T 5/20; G06T 5/70; G06V 10/762; G06V 10/764; G01N 2223/401; G06T 2207/10116; G06T 2207/20028; G06T 2207/20032; G06T 2207/20216; G06T 2207/20221; G06V 2201/05

(57) ABSTRACT

The present invention relates to a cargo inspection system. The cargo inspection system scans a cargo using a radiation beam. The cargo inspection system comprises a gateway having at least one radiation source at one side and at least one radiation detector at another side, and an image processing module. The image processing module is configured to generate one or more images based on image frames of a captured radiation, and to discriminate material in the X-ray imaging of the cargo inspection. The image processing module comprises at least one central processing unit or CPU connected to at least one graphics processing unit or GPU.

### CROSS-REFERENCE TO RELATED APPLICATION

The present application claims priority to and is based on a Malaysian application with an application number PI2023004760 and a filing date of Aug. 7, 2023, the aforementioned application is hereby incorporated by reference in its entirety.

### FIELD OF INVENTION

The present invention relates to a system and method for image processing in an X-ray imaging cargo inspection. More particularly, the present invention relates to a system and method for discriminating material in an X-ray imaging cargo inspection.

### BACKGROUND OF THE INVENTION

Image processing is used in a cargo inspection system to detect illegal or dangerous items that may be concealed within a cargo. Typically, image processing is performed by a central processing unit or CPU of the cargo inspection system. Initially, an X-ray scanner emits X-ray radiation that penetrates through the cargo and a radiation detector which is on the opposite side of the X-ray scanner captures the X-ray radiation. The radiation detector generates an image of the X-ray attenuation pattern which corresponds to the density of the materials in the cargo. The image is then pre-processed to improve the image quality by performing noise reduction, image filtering, contrast enhancement and etc. Once the pre-processing is done, the image is analysed to identify specific materials based on their physical properties whereby certain materials may have a specific density or atomic number that is different from the other materials in the cargo. By analysing the X-ray images for these differences, the system can identify and discriminate between different types of materials within the cargo. Any suspicious objects can then be detected based on their material identification in the image.

An example of the image processing performed in cargo inspection is disclosed in US Patent Publication No. 2007/0269013 which relates to a device and method for generating X-rays having different energy levels as well as a material discrimination system thereof. The method comprises the steps of generating a first pulse voltage, a second pulse voltage, a third pulse voltage and a fourth pulse voltage, generating a first electron beam having a first beam load and a second electron beam having a second beam load, respectively, based on the first pulse voltage and second pulse voltage, generating a first microwave having a first power and a second microwave having a second power, respectively, based on the third pulse voltage and the fourth pulse voltage, accelerating the first and second electron beams respectively using the first and second microwave to obtain the accelerated first electron beam and the second electron beam, hitting a target with the accelerated first electron beam and the second electron beam to generate a first X-ray and a second X-ray having different energy levels. Based on a calibration curve relationship obtained by scanning the substance of known material property, the image processing and material discrimination system classifies the digital signals which are collected after the interaction between the inspected object and the dual-energy X-ray beams so as to determine the material property of the inspected object, such as organic matter, light metal, inorganic matter, heavy metal, etc.

In another example of the image processing performed in cargo inspection is disclosed in US Patent Publication No. 2007/0286329 which relates to an energy spectrum modulation apparatus, a material discrimination method and a device thereof, as well as an image processing method that can discriminate the material in large- and medium-sized objects such as cargo containers, air cargo containers, etc. by using X-rays having different energy levels. The energy spectrum modulation apparatus comprises a first energy spectrum modulation part for modulating a first ray having a first energy spectrum, and a second energy spectrum modulation part coupled to the first energy spectrum modulation part and for modulating a second ray having a second energy spectrum different from the first energy spectrum. In discriminating an unknown material, the classification function values for the detection values of the detector are computed from the two function values of the detection values. Then, the computed values are compared with the predetermined classification function values to obtain an effective atomic number range of a material and to further determine the material attributes of the object.

The image processing of the X-ray images in cargo inspection requires high computational tasks that consume a significant amount of computational resources. This is due to the large amounts of data generated by the X-ray detector and the complexity of the computational methods used for material discrimination. Additionally, the need for real-time processing of X-ray images as cargo is moving through the X-ray scanner and detector further increases the computational demands.

Therefore, there is a need to improve the image processing of the cargo inspection so as to address the abovementioned computational demands.

### SUMMARY OF INVENTION

According to a first aspect of the present invention, a cargo inspection system (100) is disclosed. The cargo inspection system (100) comprises a gateway (110) having at least one radiation source (120) at one side and at least one radiation detector (130) at another side, and an image processing module connected to the at least one radiation detector (130), wherein the image processing module is configured to generate one or more images based on a plurality of image frames of a captured radiation and to discriminate material of the captured radiation. The image processing module is characterised by at least one central processing unit or CPU, and at least one graphics processing unit or GPU connected to the CPU. The at least one CPU includes a first CPU thread configured to obtain an image frame of the scanned cargo content from the at least one radiation detector (130), a second CPU thread configured to perform image combining based on grayscale values generated, a third CPU thread configured to perform image combining on multiple material-discriminated image frames based on material discrimination values generated, and a fourth CPU thread configured to compose at least one unified material image. The at least one GPU includes a kernel engine having a plurality of GPU threads, wherein the kernel engine is configured to execute the computation tasks of image calibration, energy merging, noise filtration, grayscale value generation and material discrimination value generation, and wherein each GPU thread is configured to execute one of the computation tasks of the kernel engine concurrently, and at least one copy engine configured for performing data transfer between the GPU and CPU.

Preferably, the image processing module further includes a fifth CPU thread configured to display either a composite grayscale image, at least one composite material discriminated image or the at least one unified material image.

Preferably, a first copy engine of the GPU is configured for copying the image frame from the first thread of the CPU to the kernel engine of the GPU. Moreover, a second copy engine is suitably configured to copy the grayscale values and the material discrimination values from the kernel engine to the second and third CPU threads respectively.

Preferably, the image processing module is further connected to a remote station or a monitor.

According to a second aspect of the present invention, a method for discriminating material in an X-ray imaging cargo inspection is disclosed. The method is characterised by the steps of capturing radiation penetrating through a portion of a cargo, wherein the captured radiation is in a form of an image frame; transmitting a set of image frames at one instance to an image processing module; copying the set of image frames to a kernel engine of the GPU; executing a computation task of image calibration on the copied set of image frames to produce a set of calibrated image frames; executing a computation task of energy merging on the set of calibrated image frames to produce a set of merged image frames; executing a computation task of grayscale value generation in parallel to computation tasks of noise filtration and material discrimination value generation, wherein the computation task of grayscale value generation generates a plurality of grayscale values in a 64-bit grayscale image format, the computation task of noise filtration produces a set of filtered image frames, and the computation task of grayscale value generation generates a plurality of material discrimination values in a red, green, blue, and alpha or RGBA 64-bit format; performing image combining on the plurality of grayscale values generated based on the set of image frames with a plurality of grayscale values generated based on at least one previous set of image frames once the plurality of grayscale values in the 64-bit grayscale image format has been generated, wherein the image combining on the plurality of grayscale values produces a composite grayscale image; performing image combining on the plurality of material discrimination values generated based on the set of image frames with a plurality of material discrimination values generated based on at least one set of image frames once the plurality of material discrimination values in the RGBA 64-bit format has been generated, wherein the image combining on the plurality of material discrimination values produces a composite material discriminated image; and composing a unified material image by overlaying the composite material discriminated image on the composite grayscale image. The computation task of image calibration includes allocating different GPU threads to different pixels of the copied set of image frames, and performing image calibration on different pixels of the copied set of image frames concurrently by each allocated GPU thread. The computation task of energy merging includes allocating different GPU threads to different pixels of the set of calibrated image frames, and interlacing each pixel line of one calibrated image frame at one energy level with another calibrated image frame at the same energy level concurrently by each allocated GPU thread

Preferably, every two of the image frames corresponds to one particular energy level of radiation.

Preferably, the image calibration is performed by adjusting each pixel value of the copied set of image frames and scaling each adjusted pixel value of the copied set of image frames.

Preferably, the execution of the computation task of grayscale value generation includes averaging the pixel values from each merged image frame at the corresponding pixel coordinates to produce a mean grayscale image frame, and converting each pixel of the mean grayscale image frame into the 64-bit grayscale image format.

Preferably, the execution of the computation task of grayscale value generation includes selecting one of the merged images; and converting each pixel of the selected merged image into the 64-bit grayscale image format.

Preferably, the execution of the computation tasks of noise filtration includes allocating different GPU threads to different pixels of the set of merged image frames; and performing noise filtration on each pixel of the set of merged image frames concurrently by each allocated GPU thread. The noise filtration is suitably performed using a bilateral filtering technique, and wherein the bilateral filtering technique includes determining neighbouring pixels around a pixel being filtered based on a predetermined filter window size, computing a range weight and a normalization factor for the pixel being filtered, and determining and applying a filtered pixel value to the pixel being filtered. Optionally, the noise filtration is suitably performed using either a median filter, a Gaussian filter, a mean filter, a non-local means filter, an adaptive manifold filter, a Perona-Malik diffusion, or a trilateral filter.

Preferably, the execution of the computation task of material discrimination value generation includes computing a value of function for each pixel; determining the proximity of each value of function to a number of trend lines on pre-generated material classification curves; and classifying each pixel into its corresponding type of material based on the proximity of its value of function to the trend lines on the pre-generated material classification curves. If there are more than two energy levels being emitted and captured, the execution of the computation task of material discrimination value generation further includes selecting two additional pairs of energy levels as a second filter for substance verification; computing a value of function for both first and second energy level pairs for each pixel; determining the proximity of each value of function to a centre of each of a plurality of pre-generated substance clusters; and classifying each pixel into its corresponding substance group based on the proximity of its value of function to the centre of each pre-generated substance cluster; and generating each pixel value in red, green, blue, and alpha or RGBA channel colour based on a colour look-up table to correspond to a particular type of material or substance group.

Preferably, the method further includes a step of displaying the unified material image, the composite grayscale image or the composite material discriminated image.

According to a third aspect of the present invention, a method for discriminating material in an X-ray imaging cargo inspection is disclosed. The method is characterised by the steps of capturing radiation penetrating through a portion of a cargo, wherein the captured radiation is in a form of an image frame; transmitting a set of image frames at one instance to an image processing module; copying the set of image frames to a kernel engine of the GPU; executing a computation task of image calibration on the copied set of image frames to produce a set of calibrated image frames; executing a computation task of energy merging on the set of calibrated image frames to produce a set of merged image frames; determining whether there are sufficient computational resources to execute the computation task of grayscale value generation in parallel to the computation tasks of noise filtration and material discrimination value generation, or not; executing a computation task of grayscale value generation in parallel to computation tasks of noise filtration and material discrimination value generation if there are sufficient computational resources, wherein the computation task of grayscale value generation generates a plurality of grayscale values in a 64-bit grayscale image format, the computation task of noise filtration produces a set of filtered image frames, and the computation task of grayscale value generation generates a plurality of material discrimination values in a red, green, blue, and alpha or RGBA 64-bit format; executing the computation tasks of grayscale value generation, noise filtration and material discrimination value generation if there are insufficient computational resources, wherein the computation task of grayscale value generation generates a plurality of grayscale values in a 64-bit grayscale image format, the computation task of noise filtration produces a set of filtered image frames, and the computation task of grayscale value generation generates a plurality of material discrimination values in a red, green, blue, and alpha or RGBA 64-bit format; performing image combining on the plurality of grayscale values generated based on the set of image frames with a plurality of grayscale values generated based on at least one previous set of image frames once the plurality of grayscale values in the 64-bit grayscale image format has been generated, wherein the image combining on the plurality of grayscale values produces a composite grayscale image; performing image combining on the plurality of material discrimination values generated based on the set of image frames with a plurality of material discrimination values generated based on at least one set of image frames once the plurality of material discrimination values in the RGBA 64-bit format has been generated, wherein the image combining on the plurality of material discrimination values produces a composite material discriminated image; and composing a unified material image by overlaying the composite material discriminated image on the composite grayscale image. The computation task of image calibration includes allocating different GPU threads to different pixels of the copied set of image frames, and performing image calibration on different pixels of the copied set of image frames concurrently by each allocated GPU thread. The computation task of energy merging includes allocating different GPU threads to different pixels of the set of calibrated image frames, and interlacing each pixel line of one calibrated image frame at one energy level with another calibrated image frame at the same energy level concurrently by each allocated GPU thread.

Preferably, every two of the image frames corresponds to one particular energy level of radiation.

Preferably, the image calibration is performed by adjusting each pixel value of the copied set of image frames and scaling each adjusted pixel value of the copied set of image frames.

Preferably, the execution of the computation task of grayscale value generation includes averaging the pixel values from each merged image frame at the corresponding pixel coordinates to produce a mean grayscale image frame, and converting each pixel of the mean grayscale image frame into the 64-bit grayscale image format.

Preferably, the execution of the computation task of grayscale value generation includes selecting one of the merged images; and converting each pixel of the selected merged image into the 64-bit grayscale image format.

Preferably, the execution of the computation tasks of noise filtration includes allocating different GPU threads to different pixels of the set of merged image frames; and performing noise filtration on each pixel of the set of merged image frames concurrently by each allocated GPU thread. The noise filtration is suitably performed using a bilateral filtering technique, and wherein the bilateral filtering technique includes determining neighbouring pixels around a pixel being filtered based on a predetermined filter window size, computing a range weight and a normalization factor for the pixel being filtered, and determining and applying a filtered pixel value to the pixel being filtered. Optionally, the noise filtration is suitably performed using either a median filter, a Gaussian filter, a mean filter, a non-local means filter, an adaptive manifold filter, a Perona-Malik diffusion, or a trilateral filter.

Preferably, the execution of the computation task of material discrimination value generation includes computing a value of function for each pixel; determining the proximity of each value of function to a number of trend lines on pre-generated material classification curves; and classifying each pixel into its corresponding type of material based on the proximity of its value of function to the trend lines on the pre-generated material classification curves. If there are more than two energy levels being emitted and captured, the execution of the computation task of material discrimination value generation further includes selecting two additional pairs of energy levels as a second filter for substance verification; computing a value of function for both first and second energy level pairs for each pixel; determining the proximity of each value of function to a centre of each of a plurality of pre-generated substance clusters; classifying each pixel into its corresponding substance group based on the proximity of its value of function to the centre of each pre-generated substance cluster; and generating each pixel value in red, green, blue, and alpha or RGBA channel colour based on a colour look-up table to correspond to a particular type of material or substance group.

Preferably, the method further includes a step of displaying the unified material image, the composite grayscale image or the composite material discriminated image.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1(a-b) illustrate an exemplary configuration of a cargo inspection system (100) for scanning a cargo.

FIG. 2 shows an example of a scan line.

FIG. 3 shows an exemplary grid structure of a plurality of GPU threads of a GPU of the cargo inspection system (100).

FIG. 4 shows a method for discriminating material in an X-ray imaging cargo inspection according to a first embodiment of the present invention.

FIG. 5 shows a method for discriminating material in an X-ray imaging cargo inspection according to a second embodiment of the present invention.

FIG. 6 shows an exemplary image frame produced by a radiation detector (130) of the cargo inspection system (100).

FIG. 7 shows an example of a set of calibrated image frames.

FIG. 8 shows an example of a set of merged image frames.

FIG. 9 shows an exemplary image of converted pixel values of a mean grayscale image frame.

### DESCRIPTION OF THE PREFERRED EMBODIMENT

A preferred embodiment of the present invention will be described herein below with reference to the accompanying drawings. In the following description, well-known functions or constructions are not described in detail since they would obscure the description with unnecessary detail.

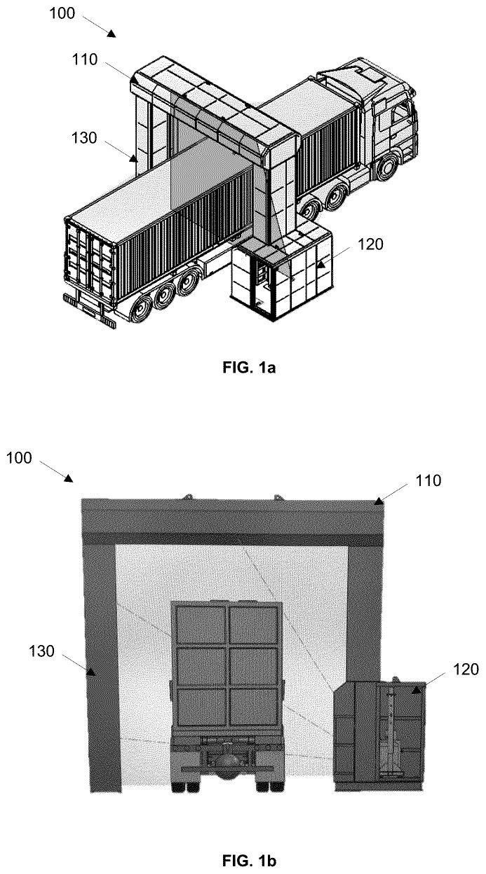

An initial reference is made to FIGS. 1(a-b) which illustrate an exemplary configuration of a cargo inspection system (100) scanning a cargo. The cargo inspection system (100) is used to scan the cargo that is being carried by a vehicle such as a lorry or truck. The cargo inspection system (100) uses a radiation beam to scan the cargo as it is driven through a gateway (110). Generally, the cargo inspection system (100) comprises the gateway (110) having at least one radiation source (120) at one side and at least one radiation detector (130) at another side, and an image processing module.

The radiation source (120) is capable to emit the radiation beam at one or multiple energy levels. The radiation source (120) can either be a linear particle accelerator or a cyclic linear accelerator. The radiation source is arranged on one side of the gateway (110).

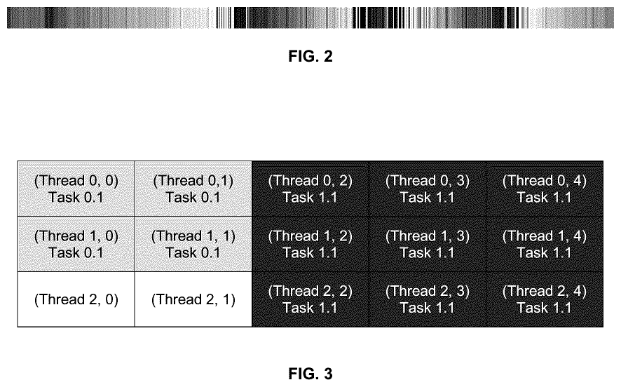

The radiation detector (130) is arranged at another side of the gateway (110) which can either be at the upper side of the gateway (110) or an opposite side of the radiation source (120). The radiation detector (130) captures and measures the radiation that penetrates through the cargo. Thus, the radiation detector (130) outputs one or more image frames based on the captured radiation at one or multiple energy levels. Each image frame relates to the captured radiation at one particular energy level. Each pixel value of the image frame includes the transmittance radiation and attenuation characteristic values. Each image frame is an assembly of multiple scan lines, wherein a scan line refers to a slice of an image that is captured at a particular sequence of time as the cargo passes through the gateway (110). An exemplary scan line is shown in FIG. 2. If there is more than one radiation detector (130), each radiation detector (130) may be aligned and positioned at different angular separations from the radiation source module (120) so as to capture different perspective angles at which the radiation passing through the cargo is detected and captured. Thus, each radiation detector (130) outputs an image frame which is an assembly of multiple scan lines of the same energy level and the same perspective angle. For example, the image frame is an assembly of 64 scan lines of the same energy level and the same perspective angle. By having multiple radiation detectors (130) capturing different perspective angles, every area of the cargo could be scanned as the cargo is driven through the gateway (110). The at least one radiation detector (130) is electrically connected to the image processing module.

The image processing module is configured to generate one or more images based on the image frames of the captured radiation. Additionally, the image processing module is configured to discriminate material in the X-ray imaging of the captured radiation of the cargo inspection. The image processing module comprises at least one central processing unit or CPU connected to at least one graphics processing unit or GPU.

The CPU has multiple CPU threads with each thread configured to execute a specific computational function so that the CPU is capable to execute multiple computational functions concurrently. A first CPU thread is configured to obtain an image frame of the scanned cargo content from the at least one radiation detector (130).

A second CPU thread is configured to perform image combining based on grayscale values generated by the GPU on a current image frame and one or more previous image frames. The image combining includes aligning, blending and merging the grayscale values of the multiple image frames. Thus, the second CPU thread produces a composite grayscale image which is a cohesive and visually continuous panoramic view of the scanned cargo content.

A third CPU thread is configured to perform image combining on multiple material-discriminated image frames based on material discrimination values generated by the GPU on a current image frame and one or more previous image frames. The image combining includes aligning, blending and merging the material discrimination values of the multiple material-discriminated image frames of a particular material and thus, producing a composite material discriminated image which is a cohesive and visually continuous representation of the distribution of the particular material within the scanned cargo. The third CPU thread may also produce multiple composite material discriminated images, wherein each composite material discriminated image is a representation of a particular material distribution.

A fourth CPU thread is configured to compose a unified material image, wherein the unified material image is a unified image that incorporates multiple material distributions to provide a comprehensive view of material information within the scanned cargo. Rather than incorporating multiple material distributions, the unified material image may also be incorporating only one material distribution and thus, the fourth CPU thread may compose multiple unified material images.

The CPU may also include a fifth CPU thread which is configured to display either the composite grayscale image, at least one of the composite material discriminated images or at least one of the unified material images. Optionally, the computation function of the fifth CPU thread may be adapted in either the first, second, third or fourth CPU threads.

The GPU is configured to perform multiple computation tasks on the image frame, wherein the computation tasks include image calibration, energy merging, noise filtration, grayscale value generation and material discrimination value generation. The GPU utilizes its multiple asynchronous execution streams which are software abstractions that manage parallel execution of the computation tasks of image calibration, energy merging, noise filtration, grayscale value generation and material discrimination value generation. The multiple asynchronous execution streams provide a way to overlap the computation tasks with data transfers between the CPU and the GPU. As a result of utilizing the multiple asynchronous execution streams, the GPU achieves better performance by exploiting parallelism and reducing latency.

The GPU includes a kernel engine and at least one copy engine. The kernel engine is configured to execute the computation tasks of image calibration, energy merging, noise filtration, grayscale value generation and material discrimination value generation. The kernel engine has multiple GPU threads, wherein each GPU thread is configured to execute one of the computation tasks of the kernel engine concurrently.

The GPU threads are organized in a hierarchical structure, with the GPU threads grouped into a plurality of blocks, and the blocks are grouped into a grid. Such structure of the GPU threads allows for efficient parallel execution of the computation tasks on the kernel engine. FIG. 3 shows an exemplary grid structure of the GPU threads. In the exemplary grid structure, there is a total of 15 GPU threads structured in a 3 by 5 grid whereby a first computation task is assigned to 4 GPU threads in a 2 by 2 grid and a second computation task is assigned to 9 GPU threads in a 3 by 3 grid.

The at least one copy engine is configured for performing data transfer between the GPU and CPU. Suitably, the GPU has two copy engines, wherein a first copy engine is configured for copying the image frame from the first thread of the CPU to the kernel engine of the GPU while a second copy engine is configured to copy the grayscale values and the material discrimination values from the kernel engine to the second and third CPU threads respectively. of the CPU. It may be appreciated that the GPU may only have one copy engine whereby all of the data transfer is being done by a single copy engine.

The image processing module may be further connected to a remote station or a monitor for displaying the images produced by the image processing module, whereby the displayed images can either be the composite grayscale image, at least one of the composite material discriminated images or at least one of the unified material images. Thus, the displayed images can be further inspected by an operator.

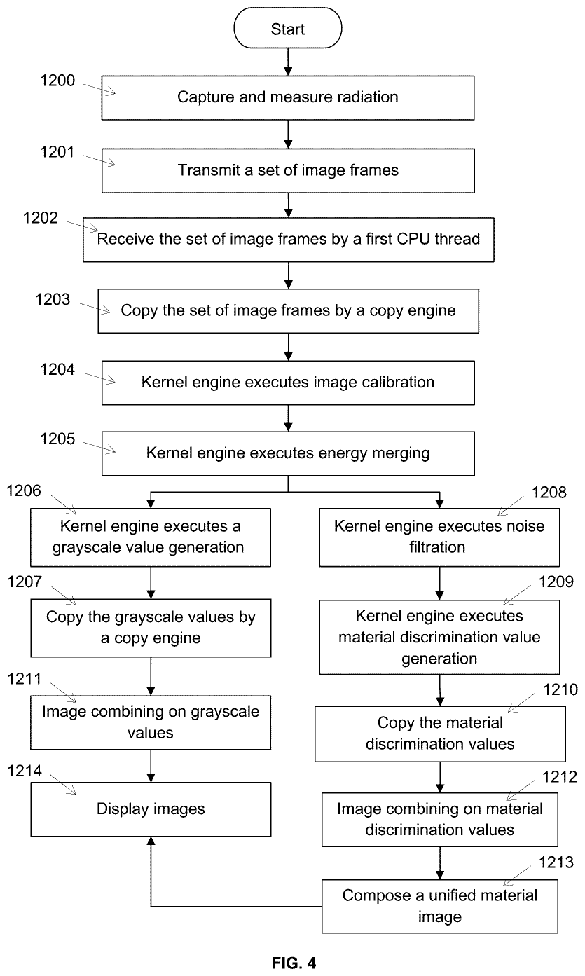

Referring now to FIG. 4, there is shown a flowchart of a method for discriminating material in an X-ray imaging cargo inspection according to a first embodiment of the present invention.

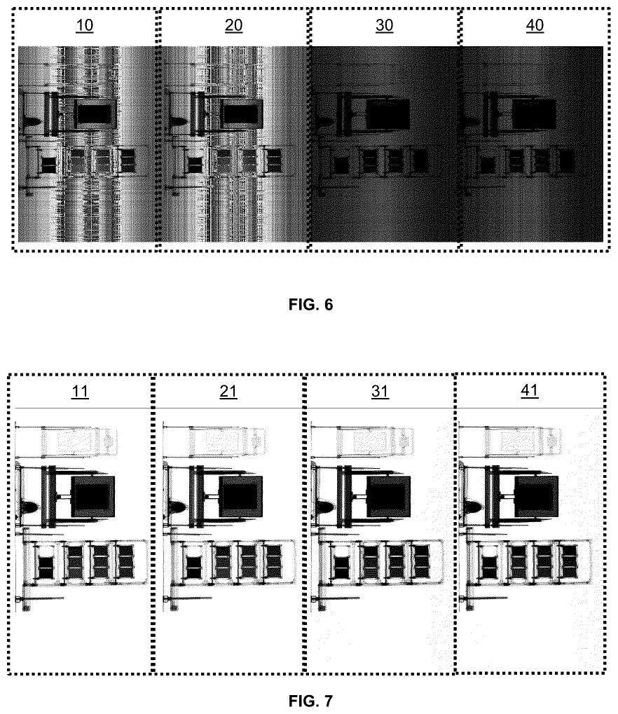

As the cargo enters the gateway (110), the radiation source (120) emits a radiation beam that penetrates through a portion of the cargo. Meanwhile, the radiation detector (130) captures and measures the radiation that penetrates through the portion of the cargo as in step 1200. Thereon, as in step 1201, the radiation detector (130) transmits the captured radiation in a form of an image frame to the image processing module. Preferably, the radiation detector (130) transmits a set of image frames at one instance to the image processing module, wherein every two of the image frames corresponds to one particular energy level of the radiation beam emitted. An exemplary set of image frames is shown in FIG. 6, wherein a first and second image frames (10, 20) correspond to a same high energy level of the radiation beam emitted while a third and fourth image frames (30, 40) correspond to a same low energy level of the radiation beam emitted.

Once the set of image frames has been transmitted to the image processing module, the first CPU thread of the CPU receives the set of image frames as in step 1202. The set of image frames is then sent from the first CPU thread to the GPU. Next, the first copy engine of the GPU copies the set of image frames to the kernel engine of the GPU as in step 1203. The method then proceeds to step 1204.

In step 1204, the kernel engine of the GPU executes the computation task of image calibration on the copied set of image frames. The kernel engine executes the computation task of image calibration by allocating different GPU threads to different pixels of the copied set of image frames, and concurrently, performing image calibration by each allocated GPU thread on different pixels of the copied set of image frames. Alternatively, each GPU thread may be allocated to multiple pixels to execute the computation task of image calibration concurrently. The image calibration is crucial in processing the image frames to reduce noise in the set of image frames so that the objects of the cargo content would be more visible. Specifically, the image calibration is performed by adjusting each pixel value of the copied set of image frames and scaling each adjusted pixel value of the copied set of image frames.

The adjustment of each pixel value of the copied set of image frames is performed by applying a first compensation value of the cargo inspection system, wherein the first compensation value is a compensation value of a hardware layout of the cargo inspection system. The first compensation value is predetermined based on radiation measurements of known reference objects or calibration phantoms with well-characterized properties. The radiation measurements of known reference object or calibration phantom help identify the spatial characteristics and variations introduced by the hardware layout across different regions of a reference image and thus, the first compensation value can be computed from the spatial characteristics and variations. By adjusting each pixel value of the copied set of image frames, the copied set of image frames is calibrated by taking into account the spatial variations introduced by the specific configuration and arrangement of components in the cargo inspection system. This ensures that the radiation measurements from different regions of the copied set of image frames are adjusted to align the radiation measurements or the pixel values with the expected spatial characteristic and thus, reflect a consistent and accurate representation of the scanned cargo content.

The scaling of each adjusted pixel value of the copied set of image frames is performed by normalizing each adjusted pixel value of the copied set of image frames using a second compensation value, wherein the second compensation value is a compensation value of dose fluctuation. The second compensation value is predetermined based on the difference between a measured or estimated X-ray dose value and a reference X-ray dose value. By scaling the adjusted pixel values of the copied set of image frames, the copied set of image frames is calibrated by taking into account the X-ray dose fluctuation during X-ray imaging due to factors such as X-ray source instability, changes in system settings, positioning of the scanned object or other environmental conditions. This ensures that the copied set of image frames accurately represents the material composition and characteristics of the scanned cargo by aligning the pixel values closer to the expected dose conditions.

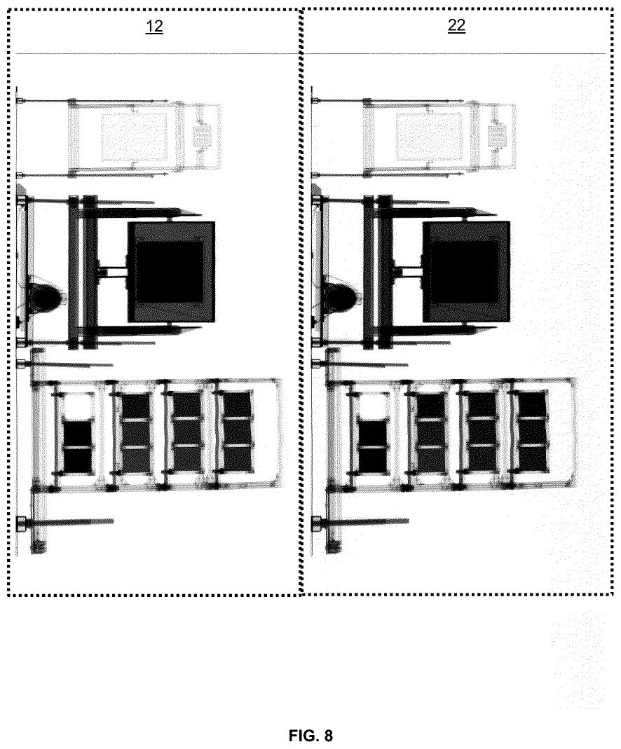

A set of calibrated image frames is produced as a result of the computation task of image calibration. FIG. 7 shows an example of the set of calibrated image frames, wherein the set of calibrated image frames is the result of image calibration on the set of image frames shown in FIG. 6. In particular, a first calibrated image frame (11) is a result of the image calibration executed on the first image frame (10), a second calibrated image frame (21) is a result of the image calibration executed on the second image frame (20), a third calibrated image frame (31) is a result of the image calibration executed on the third image frame (30), and a fourth calibrated image frame (41) is a result of the image calibration executed on the fourth image frame (40). Once the set of calibrated image frames has been produced, the method then proceeds to step 1205.

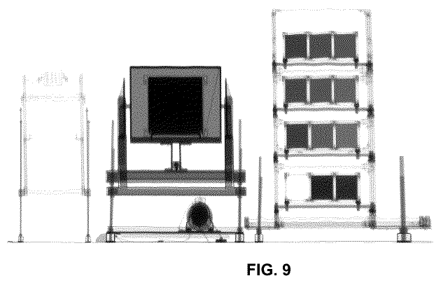

In step 1205, the kernel engine of the GPU executes the computation task of energy merging on the set of calibrated image frames. With the set of calibrated image frames having a pair of calibrated image frames at one energy level, the kernel engine merges the pair of calibrated image frames at the same energy level into a single image frame. The kernel engine executes the computation task of energy merging by allocating different GPU threads to different pixels of the set of calibrated image frames and concurrently interlacing each pixel line of one calibrated image frame at one energy level with another calibrated image frame at the same energy level by each allocated GPU threads on different pixels of the set of calibrated image frames. Alternatively, each GPU thread may be allocated to multiple pixels to execute the computation task of energy merging concurrently. A set of merged image frames is produced as a result of the computation task of energy merging. FIG. 8 shows an example of the set of merged image frames as a result of the energy merging executed by the kernel engine on the set of calibrated image frames shown in FIG. 7, wherein a first merged image frame (12) is a result of merging the first calibrated image frame (11) and the second calibrated image frame (21), while a second merged image frame (22) is a result of merging the third calibrated image frame (31) and the fourth calibrated image frame (41).

Thereon, the kernel engine of the GPU executes the computation task of grayscale value generation as in step 1206 in parallel to the computation tasks of noise filtration as in step 1208 and material discrimination value generation as in step 1209.

In step 1206, the kernel engine of the GPU generates grayscale values of the set of merged image frames by averaging the pixel values from each merged image frame at the corresponding pixel coordinates to produce a mean grayscale image frame and converting each pixel of the mean grayscale image frame into a 64-bit grayscale image format. Thus, the computation task of grayscale value generation generates a plurality of grayscale values in a 64-bit grayscale image format By averaging the pixel values of merged image frames at different energy levels, it enhances the signal-to-noise ratio and improves the image quality of the scanned cargo. The converted pixel values of the mean grayscale image frame are then copied to the second CPU thread by the second copy engine of the GPU as in step 1207. FIG. 9 shows an exemplary image of the converted pixel values of the mean grayscale image frame, wherein the mean grayscale image frame is based on the set of merged image frames of FIG. 8. Although it has been described that the kernel engine of the GPU generates grayscale values by averaging the pixel values from each merged image frame, the kernel engine of the GPU may also be adapted to generate the grayscale values by selecting one of the merged images and converting each pixel of the selected merged image into the 64-bit grayscale image format.

Once the converted pixel values have been copied to the second CPU thread, the second CPU thread performs image combining on the grayscale values generated based on the set of image frames with the grayscale values generated based on one or more previous set of image frames as in step 1211. Specifically, the image combining includes aligning, blending and merging the grayscale values based on the set of image frames with the grayscale values generated based on one or more previous set of image frames. Thus, the second CPU thread produces a composite grayscale image that is sent to the fourth CPU thread for composing a unified material image. Optionally, the composite grayscale image may also be sent to the fifth CPU thread for displaying the composite grayscale image as in step 1214.

In parallel to step 1206, the computation task of noise filtration is performed on the set of merged image frames to optimize the accuracy for material discrimination as in step 1208. The kernel engine executes the computation task of noise filtration by allocating different GPU threads to different pixels of the set of merged image frames, and concurrently, performing noise filtration on each pixel of the set of merged image frames by each allocated GPU thread. Alternatively, each GPU thread may be allocated to multiple pixels to execute the computation task of noise filtration concurrently. A bilateral filtering technique is suitably used for noise filtration by the kernel engine. The bilateral filtering technique used smoothens the set of merged image frames while preserving its edges. Specifically, the bilateral filtering technique is performed on a pixel being filtered by determining neighbouring pixels around the pixel being filtered based on a predetermined filter window size, computing a range weight and a normalization factor for the pixel being filtered, and determining and applying a filtered pixel value to the pixel being filtered. The range weight is a weighting factor assigned to each neighbouring pixel based on the difference in intensity values between the pixel being filtered and its neighbouring pixels and thus, the range weight measures the similarity of intensities between pixels within the filter window. The range weight is computed based on Equation 1 below:

$$range weight = exp ( - ( {r ( i , j )}^{2} ) / ( 2 * {σ}_{r}^{2} ) , \qquad [ Equation 1 ]$$

wherein r(i,j) is derived based on the intensity value of the pixel being filtered minus the intensity values of its neighbouring pixels, and σᵣ is an intensity standard deviation parameter. The normalization factor is computed based on Equation 2 below:

$$normalization factor = \sum ( spatial weight * range weight ) , \qquad [ Equation 2 ]$$

wherein spatial weight is a predetermined weighting factor assigned to each neighbouring pixel based on its spatial closeness from the pixel being filtered. Based on Equation 3 below, the filtered value is determined and applied to the pixel being filtered:

$$Filtered pixel = ( \frac{1}{normalization factor} ) * \sum ( neighbour pixel * spatial weight * range weight ) . \qquad [ Equation 3 ]$$

Although the GPU threads would be required to access either a shared memory or a global memory of the GPU for reading neighbouring pixels to determine the filtered pixel value, the bilateral filtering technique implemented to access the shared memory reduces the number of times the global memory is accessed and thus, shortens the time consumed for performing the noise filtration on the set of merged image frames.

Although it has been described that the bilateral filtering technique is suitably being used for noise filtration, other image filtration techniques may also be adopted such as median filter, Gaussian filter, mean filter, non-local means filter, adaptive manifold filter, Perona-Malik diffusion, and trilateral filter, for noise filtration by the kernel engine.

As a result of the computation task of noise filtration on the set of merged image frames, a set of filtered image frames is produced. The set of filtered image frames is then used by the kernel engine of the GPU to generate material discrimination values as in step 1209. Specifically, the computation task of material discrimination values generation includes computing a value of function for each pixel, determining the proximity of each value of function to a number of trend lines on pre-generated material classification curves, and classifying each pixel into its corresponding type of material based on the proximity of its value of function to the trend lines on the pre-generated material classification curves. The value of function refers to a ratio of the high-energy level of radiation emitted over the low-energy level of radiation emitted. The value of function is computed based on Equation 4 below:

$$value of function , f ( x , y ) = \frac{}{} \vert \frac{log normalised high - energy transmission {value}_{( x , y )}}{log normalised low - energy transmission {value}_{( x , y )}} \vert \qquad [ Equation 4 ]$$

Each trend line on the pre-generated material classification curves relates to a particular type of material. Examples of the types of materials are organic, an intermediate mixture of organic and inorganic, inorganic, and heavy metal. If there are areas of overlapping for the material curve during classification, one material will be prioritised over other materials based on the distance between the values of function to the trend lines of the materials.

If there are more than two energy levels being emitted and captured, the computation task of material discrimination values generation may further include the additional steps of selecting two additional pairs of energy levels as a second filter for substance verification, computing a value of function for both first and second energy level pairs for each pixel, determining the proximity of each value of function to a centre of each of a plurality of pre-generated substance clusters, and classifying each pixel into its corresponding substance group based on the proximity of its value of function to the centre of each pre-generated substance cluster. The two additional pairs of energy levels are selected from any possible combinations from the multiple energy level radiation. The computation of the values of function for the first energy level and second energy pairs are based on Equation 4. The centre of each substance cluster is determined suitably by a K-means clustering algorithm.

After the pixels are classified into their types of materials or substance groups, the kernel engine generates each pixel value in red, green, blue, and alpha (RGBA) channel colour based on a colour look-up table so as to correspond to a particular type of material or substance group. Thus, the kernel engine generates the material discrimination values in RGBA 64-bit format. The material discrimination values are then copied to the third CPU thread by the second copy engine of the GPU as in step 1210.

Once the material discrimination values have been copied to the third CPU thread, the third CPU thread performs image combining on material discrimination values generated based on the set of image frames with the material discrimination values generated based on one or more previous set of image frames as in step 1212. Specifically, the image combining includes aligning, blending and merging the material discrimination values based on the set of image frames with the material discrimination values generated based on one or more previous set of image frames. Thus, the third CPU thread produces a composite material discriminated image that is sent to the fourth CPU thread.

Once the fourth CPU thread receives the composite grayscale image and the composite material discriminated image, the fourth CPU thread composes a unified material image as in step 1213 by overlaying the composite material discriminated image on the composite grayscale image. Thus, the unified material image incorporates multiple material distributions to provide a comprehensive view of material information within the scanned cargo.

Next, as in step 1214, the fifth CPU thread displays the unified material image on a monitor or at a remote station. Thus, the cargo content can be inspected by an operator based on the unified material image being displayed. Optionally, the fifth CPU thread may also display the composite grayscale image or the composite material discriminated image.

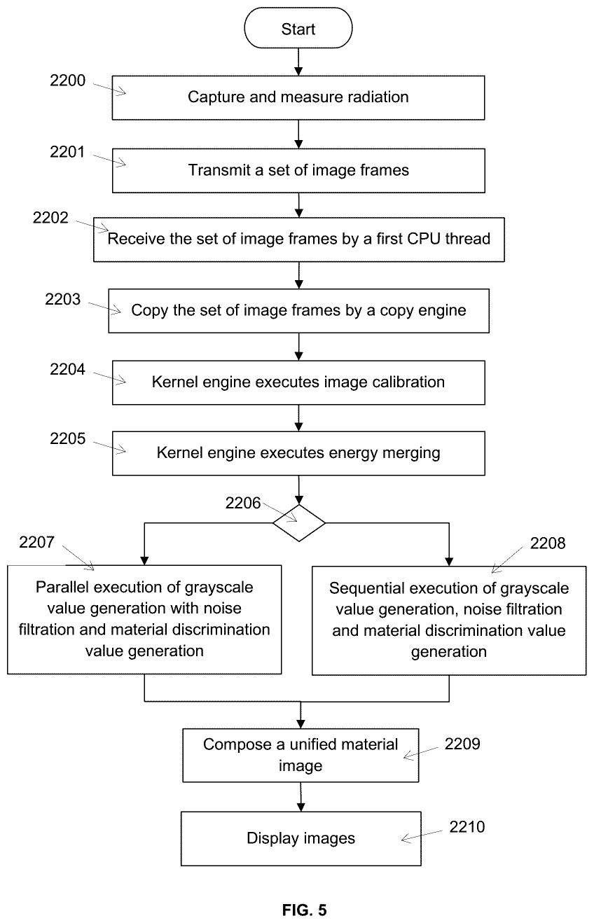

Referring now to FIG. 5, there is shown a flowchart of a method for discriminating material in an X-ray imaging cargo inspection according to a second embodiment of the present invention.

As the cargo enters the gateway (110), the radiation source (120) emits a radiation beam that penetrates through a portion of the cargo. Meanwhile, the radiation detector (130) captures and measures the radiation that penetrates through the portion of the cargo as in step 2200. Next, as in step 2201, the radiation detector (130) transmits the captured radiation in a form of an image frame to the image processing module. Preferably, the radiation detector (130) transmits a set of image frames at one instance to the image processing module, wherein every two of the image frames corresponds to one particular energy level of the radiation beam emitted.

Once the set of image frames has been transmitted to the image processing module, the first CPU thread of the CPU receives the set of image frames as in step 2202. The set of image frames is then sent from the first CPU thread to the GPU. Next, the first copy engine of the GPU copies the set of image frames to the kernel engine of the GPU as in step 2203. The method then proceeds to step 2204.

In step 2204, the kernel engine of the GPU executes the computation task of image calibration on the copied set of image frames. The kernel engine executes the computation task of image calibration by allocating different GPU threads to different pixels of the copied set of image frames, and concurrently, performing image calibration by each allocated GPU thread on different pixels of the copied set of image frames. Alternatively, each GPU thread may be allocated to multiple pixels to execute the computation task of image calibration concurrently. The computation task of image calibration is similar to step 1204 of FIG. 4 whereby the image calibration is performed by adjusting each pixel value of the copied set of image frames and scaling each adjusted pixel value of the copied set of image frames. As a result of the computation task of image calibration, a set of calibrated image frames is produced. The method then proceeds to step 2205.

In step 2205, the kernel engine of the GPU executes the computation task of energy merging on the set of calibrated image frames. The computation task of energy merging is similar to step 1205 of FIG. 4 whereby the computation task of image calibration is executed by allocating different GPU threads to different pixels of the set of calibrated image frames and concurrently interlacing each pixel line of one calibrated image frame at one energy level with another calibrated image frame at the same energy level by each allocated GPU threads on different pixels of the set of calibrated image frames. Alternatively, each GPU thread may be allocated to multiple pixels to execute the computation task of energy merging concurrently. As a result of the computation task of energy merging, a set of merged image frames is produced.

Thereon, as in decision 2206, the GPU determines whether there are sufficient computational resources to execute the computation task of grayscale value generation in parallel to the computation tasks of noise filtration and material discrimination value generation or not.

If there are sufficient computational resources, the kernel engine of the GPU executes the computation task of grayscale value generation in parallel to the computation tasks of noise filtration and material discrimination value generation as in step 2207.

Thus, at one instance, the kernel engine of the GPU initiates the computation task execution of grayscale value generation, wherein the computation task of grayscale value generation includes generating grayscale values of the set of merged image frames by averaging the pixel values from each merged image frame at the corresponding pixel coordinates to produce a mean grayscale image frame; and converting each pixel of the mean grayscale image frame into a 64-bit grayscale image format. Although it has been described that the kernel engine of the GPU generates grayscale values by averaging the pixel values from each merged image frame, the kernel engine of the GPU may also be adapted to generate the grayscale values by selecting one of the merged images and converting each pixel of the selected merged image into the 64-bit grayscale image format.

Thereon, the converted pixel values are then copied to the second CPU thread by the second copy engine of the GPU.

Once the converted pixel values have been copied to the second CPU thread, the second CPU thread performs image combining on grayscale values generated based on the set of image frames with the grayscale values generated based on one or more previous set of image frames. Thus, the second CPU thread produces a composite grayscale image that is sent to the fourth CPU thread for composing a unified material image. Optionally, the composite grayscale image may also be sent to the fifth CPU thread for displaying the composite grayscale image as in step 2210.

At the same instance, the kernel engine of the GPU initiates the computation task execution of noise filtration, wherein the computation task of noise filtration includes allocating different GPU threads to different pixels of the set of merged image frames, and concurrently, performing noise filtration on each pixel of the set of merged image frames by each allocated GPU threads. Alternatively, each GPU thread may be allocated to multiple pixels to execute the computation task of noise filtration concurrently. A bilateral filtering technique is suitably used for noise filtration by the kernel engine. Other image filtration techniques may also be adopted such as median filter, Gaussian filter, mean filter, non-local means filter, adaptive manifold filter, Perona-Malik diffusion, and trilateral filter, for noise filtration by the kernel engine.

As a result of the computation task of noise filtration on the set of merged image frames, a set of filtered image frames is produced. The set of filtered image frames is then used by the kernel engine of the GPU to generate material discrimination values. The computation task of material discrimination values generation is similar to step 1209 of FIG. 4. As a result, the kernel engine generates the material discrimination values in RGBA 64-bit format. The material discrimination values are then copied to the third CPU thread by the second copy engine of the GPU.

Once the material discrimination values have been copied to the third CPU thread, the third CPU thread performs image combining on material discrimination values generated based on the set of image frames with the material discrimination values generated based on one or more previous set of image frames. Thus, the third CPU thread produces a composite material discriminated image that is sent to the fourth CPU thread. The method then proceeds to step 2209.

If there are insufficient computational resources, the kernel engine of the GPU executes the computation tasks of grayscale value generation, noise filtration and material discrimination value generation in sequence.

The computation task of grayscale value generation includes generating grayscale values of the set of merged image frames by averaging the pixel values from each merged image frame at the corresponding pixel coordinates to produce a mean grayscale image frame, and converting each pixel of the mean grayscale image frame into a 64-bit grayscale image format. Although it has been described that the kernel engine of the GPU generates grayscale values by averaging the pixel values from each merged image frame, the kernel engine of the GPU may also be adapted to generate the grayscale values by selecting one of the merged images and converting each pixel of the selected merged image into the 64-bit grayscale image format.

Thereon, the converted pixel values are then copied to the second CPU thread by the second copy engine of the GPU. Once the converted pixel values have been copied to the second CPU thread, the second CPU thread performs image combining on grayscale values generated based on the set of image frames with the grayscale values generated based on one or more previous set of image frames. Thus, the second CPU thread produces a composite grayscale image that is sent to the fourth CPU thread for composing a unified material image. Optionally, the composite grayscale image may also be sent to the fifth CPU thread for displaying the composite grayscale image as in step 2210.

Next, the kernel engine of the GPU executes the computation task of noise filtration by allocating different GPU threads to different pixels of the set of merged image frames, and concurrently, performing noise filtration on each pixel of the set of merged image frames by each allocated GPU threads. Alternatively, each GPU thread may be allocated to multiple pixels to execute the computation task of noise filtration concurrently. A bilateral filtering technique is suitably used for noise filtration by the kernel engine. Other image filtration techniques may also be adopted such as median filter, Gaussian filter, mean filter, non-local means filter, adaptive manifold filter, Perona-Malik diffusion, and trilateral filter, for noise filtration by the kernel engine. As a result of the computation task of noise filtration on the set of merged image frames, a set of filtered image frames is produced. The set of filtered image frames is then used by the kernel engine of the GPU to generate material discrimination values. The computation task of material discrimination values generation is similar to step 1209 of FIG. 4. As a result, the kernel engine generates the material discrimination values in RGBA 64-bit format. The material discrimination values are then copied to the third CPU thread by the second copy engine of the GPU.

Once the material discrimination values have been copied to the third CPU thread, the third CPU thread performs image combining on material discrimination values generated based on the set of image frames with the material discrimination values generated based on one or more previous set of image frames. Thus, the third CPU thread produces a composite material discriminated image that is sent to the fourth CPU thread. The method then proceeds to step 2209.

In step 2209, the fourth CPU thread composes a unified material image once the fourth CPU thread receives the composite grayscale image and the composite material discriminated image. The unified material image is composed by overlaying the composite material discriminated image on the composite grayscale image.

In step 2210, the fifth CPU thread displays the unified material image on a monitor or at a remote station. Optionally, the fifth CPU thread may also display the composite grayscale image or the composite material discriminated image.

While embodiments of the invention have been illustrated and described, it is not intended that these embodiments illustrate and describe all possible forms of the invention. Rather, the words used in the specifications are words of description rather than limitation and various changes may be made without departing from the scope of the invention.

1. A cargo inspection system comprising:
a) a gateway having at least one radiation source at one side and at least one radiation detector at another side, and
b) an image processing module connected to the at least one radiation detector, wherein the image processing module is configured to generate one or more images based on a plurality of image frames of a captured radiation and to discriminate material of the captured radiation,
wherein the image processing module is characterised by:
c) at least one central processing unit or CPU, wherein the at least one CPU includes:
i. a first CPU thread configured to obtain an image frame of the scanned cargo content from the at least one radiation detector,
ii. a second CPU thread configured to perform image combining based on grayscale values generated,
iii. a third CPU thread configured to perform image combining on multiple material-discriminated image frames based on material discrimination values generated, and
iv. a fourth CPU thread configured to compose at least one unified material image; and
d) at least one graphics processing unit or GPU connected to the CPU, wherein the at least one GPU includes:
i. a kernel engine having a plurality of GPU threads, wherein the kernel engine is configured to execute the computation tasks of image calibration, energy merging, noise filtration, grayscale value generation and material discrimination value generation, and wherein each GPU thread is configured to execute one of the computation tasks of the kernel engine concurrently, and
ii. at least one copy engine configured for performing data transfer between the GPU and CPU.

2. The cargo inspection system as claimed in claim 1, wherein the image processing module further includes a fifth CPU thread configured to display either a composite grayscale image, at least one composite material discriminated image or the at least one unified material image.

3. The cargo inspection system as claimed in claim 1, wherein a first copy engine of the GPU is configured for copying the image frame from the first thread of the CPU to the kernel engine of the GPU.

4. The cargo inspection system as claimed in claim 3, wherein a second copy engine is configured to copy the grayscale values and the material discrimination values from the kernel engine to the second and third CPU threads respectively.

5. The cargo inspection system as claimed in claim 1, wherein the image processing module is further connected to a remote station or a monitor.

6. A method for discriminating material in an X-ray imaging cargo inspection is characterised by the steps of:
a) capturing radiation penetrating through a portion of a cargo, wherein the captured radiation is in a form of an image frame;
b) transmitting a set of image frames at one instance to an image processing module;
c) copying the set of image frames to a kernel engine of the GPU;
d) executing a computation task of image calibration on the copied set of image frames to produce a set of calibrated image frames, wherein the computation task of image calibration includes:
i. allocating different GPU threads to different pixels of the copied set of image frames, and
ii. performing image calibration on different pixels of the copied set of image frames concurrently by each allocated GPU thread;
e) executing a computation task of energy merging on the set of calibrated image frames to produce a set of merged image frames, wherein the computation task of energy merging includes:
i. allocating different GPU threads to different pixels of the set of calibrated image frames, and
ii. interlacing each pixel line of one calibrated image frame at one energy level with another calibrated image frame at the same energy level concurrently by each allocated GPU thread;
f) executing a computation task of grayscale value generation in parallel to computation tasks of noise filtration and material discrimination value generation, wherein the computation task of grayscale value generation generates a plurality of grayscale values in a 64-bit grayscale image format, the computation task of noise filtration produces a set of filtered image frames, and the computation task of grayscale value generation generates a plurality of material discrimination values in a red, green, blue, and alpha or RGBA 64-bit format;
g) performing image combining on the plurality of grayscale values generated based on the set of image frames with a plurality of grayscale values generated based on at least one previous set of image frames once the plurality of grayscale values in the 64-bit grayscale image format has been generated, wherein the image combining on the plurality of grayscale values produces a composite grayscale image;
h) performing image combining on the plurality of material discrimination values generated based on the set of image frames with a plurality of material discrimination values generated based on at least one set of image frames once the plurality of material discrimination values in the RGBA 64-bit format has been generated, wherein the image combining on the plurality of material discrimination values produces a composite material discriminated image; and
i) composing a unified material image by overlaying the composite material discriminated image on the composite grayscale image.

7. The method as claimed in claim 6, wherein every two of the image frames corresponds to one particular energy level of radiation.

8. The method as claimed in claim 6, wherein the image calibration is performed by adjusting each pixel value of the copied set of image frames and scaling each adjusted pixel value of the copied set of image frames.

9. The method as claimed in claim 6, wherein the execution of the computation task of grayscale value generation includes:
a) averaging the pixel values from each merged image frame at the corresponding pixel coordinates to produce a mean grayscale image frame, and
b) converting each pixel of the mean grayscale image frame into the 64-bit grayscale image format.

10. The method as claimed in claim 6, wherein the execution of the computation task of grayscale value generation includes:
a) selecting one of the merged images; and
b) converting each pixel of the selected merged image into the 64-bit grayscale image format.

11. The method as claimed in claim 6, wherein the execution of the computation tasks of noise filtration includes:
a) allocating different GPU threads to different pixels of the set of merged image frames; and
b) performing noise filtration on each pixel of the set of merged image frames concurrently by each allocated GPU thread.

12. The method as claimed in claim 11, wherein the noise filtration is performed using a bilateral filtering technique, and wherein the bilateral filtering technique includes:
a) determining neighbouring pixels around a pixel being filtered based on a predetermined filter window size,
b) computing a range weight and a normalization factor for the pixel being filtered, and
c) determining and applying a filtered pixel value to the pixel being filtered.

13. The method as claimed in claim 11, wherein the noise filtration is performed using either a median filter, a Gaussian filter, a mean filter, a non-local means filter, an adaptive manifold filter, a Perona-Malik diffusion, or a trilateral filter.

14. The method as claimed in claim 6, wherein the execution of the computation task of material discrimination value generation includes:
a) computing a value of function for each pixel;
b) determining the proximity of each value of function to a number of trend lines on pre-generated material classification curves; and
c) classifying each pixel into its corresponding type of material based on the proximity of its value of function to the trend lines on the pre-generated material classification curves.

15. The method as claimed in claim 14, wherein if there are more than two energy levels being emitted and captured, the execution of the computation task of material discrimination value generation further includes:
a) selecting two additional pairs of energy levels as a second filter for substance verification;
b) computing a value of function for both first and second energy level pairs for each pixel;
c) determining the proximity of each value of function to a centre of each of a plurality of pre-generated substance clusters; and
d) classifying each pixel into its corresponding substance group based on the proximity of its value of function to the centre of each pre-generated substance cluster; and
e) generating each pixel value in red, green, blue, and alpha or RGBA channel colour based on a colour look-up table to correspond to a particular type of material or substance group.

16. The method as claimed in claim 6, wherein the method further includes a step of displaying the unified material image, the composite grayscale image or the composite material discriminated image.

17. A method for discriminating material in an X-ray imaging cargo inspection is characterised by the steps of:
a) capturing radiation penetrating through a portion of a cargo, wherein the captured radiation is in a form of an image frame;
b) transmitting a set of image frames at one instance to an image processing module;
c) copying the set of image frames to a kernel engine of the GPU;
d) executing a computation task of image calibration on the copied set of image frames to produce a set of calibrated image frames, wherein the computation task of image calibration includes:
i. allocating different GPU threads to different pixels of the copied set of image frames, and
ii. performing image calibration on different pixels of the copied set of image frames concurrently by each allocated GPU thread;
e) executing a computation task of energy merging on the set of calibrated image frames to produce a set of merged image frames, wherein the computation task of energy merging includes:
i. allocating different GPU threads to different pixels of the set of calibrated image frames, and
ii. interlacing each pixel line of one calibrated image frame at one energy level with another calibrated image frame at the same energy level concurrently by each allocated GPU thread;
f) determining whether there are sufficient computational resources to execute the computation task of grayscale value generation in parallel to the computation tasks of noise filtration and material discrimination value generation, or not;
g) executing a computation task of grayscale value generation in parallel to computation tasks of noise filtration and material discrimination value generation if there are sufficient computational resources, wherein the computation task of grayscale value generation generates a plurality of grayscale values in a 64-bit grayscale image format, the computation task of noise filtration produces a set of filtered image frames, and the computation task of grayscale value generation generates a plurality of material discrimination values in a red, green, blue, and alpha or RGBA 64-bit format;
h) executing the computation tasks of grayscale value generation, noise filtration and material discrimination value generation if there are insufficient computational resources, wherein the computation task of grayscale value generation generates a plurality of grayscale values in a 64-bit grayscale image format, the computation task of noise filtration produces a set of filtered image frames, and the computation task of grayscale value generation generates a plurality of material discrimination values in a red, green, blue, and alpha or RGBA 64-bit format;
i) performing image combining on the plurality of grayscale values generated based on the set of image frames with a plurality of grayscale values generated based on at least one previous set of image frames once the plurality of grayscale values in the 64-bit grayscale image format has been generated, wherein the image combining on the plurality of grayscale values produces a composite grayscale image;
j) performing image combining on the plurality of material discrimination values generated based on the set of image frames with a plurality of material discrimination values generated based on at least one set of image frames once the plurality of material discrimination values in the RGBA 64-bit format has been generated, wherein the image combining on the plurality of material discrimination values produces a composite material discriminated image; and
k) composing a unified material image by overlaying the composite material discriminated image on the composite grayscale image.

18. The method as claimed in claim 17, wherein every two of the image frames corresponds to one particular energy level of radiation.

19. The method as claimed in claim 17, wherein the image calibration is performed by adjusting each pixel value of the copied set of image frames and scaling each adjusted pixel value of the copied set of image frames.

20. The method as claimed in claim 17, wherein the execution of the computation task of grayscale value generation includes:
a) averaging the pixel values from each merged image frame at the corresponding pixel coordinates to produce a mean grayscale image frame, and
b) converting each pixel of the mean grayscale image frame into the 64-bit grayscale image format.

21. The method as claimed in claim 17, wherein the execution of the computation task of grayscale value generation includes:
a) selecting one of the merged images; and
b) converting each pixel of the selected merged image into the 64-bit grayscale image format.

22. The method as claimed in claim 17, wherein the execution of the computation tasks of noise filtration includes:
a) allocating different GPU threads to different pixels of the set of merged image frames; and
b) performing noise filtration on each pixel of the set of merged image frames concurrently by each allocated GPU thread.

23. The method as claimed in claim 22, wherein the noise filtration is performed using a bilateral filtering technique, and wherein the bilateral filtering technique includes:
a) determining neighbouring pixels around a pixel being filtered based on a predetermined filter window size,
b) computing a range weight and a normalization factor for the pixel being filtered, and
c) determining and applying a filtered pixel value to the pixel being filtered.

24. The method as claimed in claim 22, wherein the noise filtration is performed using either a median filter, a Gaussian filter, a mean filter, a non-local means filter, an adaptive manifold filter, a Perona-Malik diffusion, or a trilateral filter.

25. The method as claimed in claim 17, wherein the execution of the computation task of material discrimination value generation includes:
a) computing a value of function for each pixel;
b) determining the proximity of each value of function to a number of trend lines on pre-generated material classification curves; and
c) classifying each pixel into its corresponding type of material based on the proximity of its value of function to the trend lines on the pre-generated material classification curves.

26. The method as claimed in claim 25, wherein if there are more than two energy levels being emitted and captured, the execution of the computation task of material discrimination value generation further includes:
a) selecting two additional pairs of energy levels as a second filter for substance verification;
b) computing a value of function for both first and second energy level pairs for each pixel;
c) determining the proximity of each value of function to a centre of each of a plurality of pre-generated substance clusters;
d) classifying each pixel into its corresponding substance group based on the proximity of its value of function to the centre of each pre-generated substance cluster; and
e) generating each pixel value in red, green, blue, and alpha or RGBA channel colour based on a colour look-up table to correspond to a particular type of material or substance group.

27. The method as claimed in claim 17, wherein the method further includes a step of displaying the unified material image, the composite grayscale image or the composite material discriminated image.
